(19) United States
(12) Patent Application Publication
(10) Pub. No.: US 2024/0246018 A1
(43) Pub. Date: Jul. 25, 2024

(54) FILTER ELEMENT FOR FILTERING AIR AND AIR FILTER

(71) Applicant: MANN+HUMMEL GmbH, Ludwigsburg (DE)

(72) Inventors: Thilo MÜLLER, Karlsruhe (DE); Peter MEJSNAR, Povazska Bystrica (SK)

(21) Appl. No.: 18/626,588

(22) Filed: Apr. 4, 2024

Related U.S. Application Data
(63) Continuation of application No. PCT/EP2022/073957, filed on Aug. 29, 2022.

(30) Foreign Application Priority Data
Oct. 11, 2021 (DE) 102021126246.1

(51) Int. Cl. B01D 46/52; B01D 46/00

(52) U.S. Cl. CPC B01D 46/521; B01D 46/0005; B01D 2201/34

(57) ABSTRACT

A filter element for filtering air has a filter body with a folded filter medium provided with fold edges. A first side strip made of a fibrous material is provided, wherein the first side strip has a seal section, wherein the seal section seals the filter body at a first end face extending transversely to the fold edges of the filter medium, and wherein the first side strip has also a first tab projecting away from the seal section and extending in a direction of the fold edges. A circumferential seal engages around the first tab. An air filter is provided with such a filter element. A filter device provided with a flow channel permitting an air flow therethrough has such a filter element disposed therein, wherein the filter element extends perpendicularly to a direction of the air flow through the flow channel.

### CROSS-REFERENCE TO RELATED APPLICATIONS

This application is a continuation application of international application No. PCT/EP2022/073957 having an international filing date of Aug. 29, 2022, and designating the United States, the international application claiming a priority date of Oct. 11, 2021, based on prior-filed German patent application No. 10 2021 126 246.1, the entire contents of the aforesaid international application and the aforesaid German patent application being incorporated herein by reference.

### BACKGROUND

Air is an important component needed for the proper functioning of some machines, including, e.g., internal combustion engines. For the machines to operate efficiently, the air should be clean, meaning not contaminated with pollutants or particulate. Similarly, for vehicles with cabins, air may be circulated into a cabin containing a driver and passengers. The air sent into the cabin should also be clean, meaning not contaminated with pollutants or particulate. Filtering air for use in machines or by persons in a cabin has been a source of innovation for some time.

DE 10 2009 056 511 A1 concerns a filter element with a fold pack. A plastic frame is molded onto the fold pack. A plastic foam seal is foamed onto the plastic frame.

U.S. Pat. No. 5,795,361 A discloses an air filter element in which a folded filter medium is arranged inside of a plastic frame. The filter medium is held at the plastic frame by a seal material which is used for sealing in relation to a filter housing in which the air filter element is disposed.

### SUMMARY

In the case of large air filter elements, a sufficiently stiff and stable mount at the filter housing is required due to its own weight and the weight of the deposited dust. At the same time, a reliable sealing action between the filter element and the filter housing or its housing parts is necessary. It is an object of the invention to provide an inexpensively producible filter element which can be safely fixed at the filter housing.

In accordance with the invention, this object is solved by a filter element for filtering air which comprises the following features:
a) a filter body comprising a folded filter medium;
b) a first side strip of a fibrous material, comprising a seal section which seals the filter body at an end face which extends transversely to the fold edges of the filter medium, and comprising a first tab projecting away from the seal section and, in one embodiment, extending in direction of the fold edges;
c) a circumferential seal which engages around the first tab.

### BRIEF DESCRIPTION OF THE DRAWINGS

Features and advantages of the invention result from the following detailed description of embodiments of the invention, from the claims as well as with the aid of the Figures showing details according to the invention. The aforementioned and still to be explained features can be realized individually by themselves, respectively, or several combined in arbitrary expedient combinations in variants of the invention. The features shown in the drawing are illustrated such that the particularities of the invention can be made clearly visible.

FIG. 1 shows a schematic cross section through an air filter according to the invention with a filter element according to the invention.

FIG. 2 shows a schematic longitudinal section through a filter body of a filter element according to the invention.

FIG. 3 shows a schematic perspective view of a filter element according to the invention.

FIG. 4 shows a cross section through the filter element of FIG. 3 in a schematic detail view.

FIG. 5 shows a longitudinal section through the filter element of FIG. 3 in a schematic detail view.

FIG. 6 shows a cross section through a further embodiment of a filter element according to the invention in a schematic detail view.

FIG. 7 shows a longitudinal section through the further embodiment of the filter element in a schematic detail view.

FIG. 8 shows a schematic perspective view of a third embodiment of the filter element.

FIG. 9 shows schematically a filter device with a flow channel.

### DETAILED DESCRIPTION

As mentioned previously, it is an object of the invention to provide an inexpensively producible filter element which can be safely fixed at the filter housing. In accordance with the invention, this object is solved by a filter element for filtering air which comprises the following features:
a) a filter body comprising a folded filter medium;
b) a first side strip of a fibrous material, comprising a seal section which seals the filter body at an end face which extends transversely to the fold edges of the filter medium, and comprising a first tab projecting away from the seal section and extending preferably in direction of the fold edges;
c) a circumferential seal which engages around the first tab.

Preferred embodiments are disclosed in the dependent claims and the description.

Fibrous material for the first side strip is characterized advantageously by a comparatively high bending stiffness and minimal production costs. The fibrous material may comprise cellulose or plastic materials, for example, plastic fibers, in particular polyester such as PET or CoPET. By means of cellulose, in particular cellulose fibers, a high bending stiffness and tensile strength of the side strip can be achieved and, simultaneous, biodegradability and thus high environmental compatibility. Plastic fibers also provide high tensile strength and stiffness and can be comprised, ecologically advantageously, at least partially of recycled plastic material. In some configurations of the filter element, the fibrous material can be coated. As an alternative or in addition to the fibrous material, the first side strip can comprise plastic films of various thicknesses, foam material and/or cardboard.

In particular, a direction of a fold edge is defined as the direction of a straight line which extends along this fold edge. The fold edges can be oriented in various ways including parallel to each other. The first tab, as a basic principle, is oriented away from the filter body. The first tab may be fastened to the side strip at the side of the side strip positioned opposite the filter bellows. The orientation of the fold edges may coincide with the orientation of the first tab. In an embodiment, the seal is arranged on the entire surface of the first tab. In case of terminal arrangement of the tab, the seal engages in particular in folds of the filter body to which it is fastened. In addition to separating a raw air space from a clean air space, the seal fulfills also the purpose of fixing the filter element in the filter housing. The seal section of the side strip serves for sealing the filter element at open sides of the folds. The first tab of the first side strip effects a more stable joining of the seal to the side strip. This more stable joining is achieved, on the one hand, in that the tab leads to an enlargement of the joining surface of the seal. On the other hand, the seal is mechanically stiffened by the tab. The tab prevents detachment of the seal, for example, by peeling. This is in particular advantageous when the filter elements are clamped without further housing-side support at their seal, for example, in building filter units with typical frames according to DIN EN 15805, in particular for accommodating seals of a thickness of 25 mm and 20 mm. The stiffness of the seal and the pull-off forces in relation to the interface at the remaining filter element must be designed in this context in particular such that the static and/or dynamic loads do not cause significant deformation, leaks or peeling off of the seal from the remaining filter element throughout the service life of the component.

In some embodiments, the filter body comprises, perpendicularly to the fold edges of the folds, a profile that is combined of individual bellows arranged so as to adjoin each other. The filter element in other words can be, for example, a V-Bank filter or W-Bank filter and can have a plurality of filter bellows. The individual bellows are arranged in particular in a V shape or W shape. The folds of the filter body may extend in a zigzag shape along the legs of the profiles. In particular, end folds at the ends of the individual bellows can be arranged so as to adjoin each other in order to provide joining surfaces for the seal.

The filter body may be glued to the side strip.

Here, the term circumferential may have in particular the meaning that the seal engages around the filter body. The end faces of the filter element relate in particular to the sides of the filter element which delimit the filter element in the direction of the fold edges. The term fold edges refers in particular to bending edges of the folds and/or to crown lines of the folds when the folds are embodied in a curved configuration. The seal section may be embodied as a wall-shaped component.

The seal section at the first side strip extends typically in a length direction and a vertical axis direction of the filter body. The length direction extends in general transversely to the orientation of the fold edges. In particular, the profile of the filter body extends in the length direction of the filter body. The vertical axis direction of the filter body can extend perpendicularly to the orientation of the fold edges and perpendicularly to the length direction of the filter body. For describing the present invention, the terms Atop@ and Abottom@ relate in particular to the vertical axis direction.

In an embodiment of the filter element, the first tab is arranged terminally at the seal section. This simplifies the production of the side strip. In addition, the material consumption for the seal can be reduced in this embodiment, in particular at an outer side of the seal section. In the context of the present invention, in particular a position at a top or bottom edge of the seal section is defined as terminal, wherein the top edge and bottom edge of the seal section in the vertical axis direction are spaced apart from each other and extend in the length direction or circumferential direction of the filter body.

In one embodiment of the filter element, the seal section extends at both sides of the first tab. The first tab is arranged in the vertical axis direction between the top edge and the bottom edge of the seal section. In such a configuration, the seal extends also at the outer face of the seal section which is facing away from the filter body so that the joining surface of the seal is enlarged. Thus, the seal is embodied more stably. In this embodiment, the seal can be positioned along the height of the filter element away from the rim of the filter element, in particular the top rim, whereby, on the one hand, a lower total height can be advantageously realized. Furthermore, in this way joining of a seal extending parallel to the horizontal is possible also for filter elements which have an arbitrary geometry deviating from a cuboid shape, for example, a wedge shape. This embodiment is advantageous in particular in case of large, heavy filter elements. In addition, the weight distribution can be improved for vertically mounted filter elements so that the moments acting at the seal can be minimized. The term Avertical@ relates in particular to the direction of the force of gravity. Vertically mounted filter elements are oriented in particular in such a way that their inflow surface extends in vertical direction.

In some embodiments of the filter element, the first tab is embodied as a single layer. In this embodiment, the side strip comprises in particular an L profile in cross section with two legs extending away from each other. The tab can be projecting away from the seal section in such a way that the seal section and the tab form an L profile in cross section. This concerns in particular embodiments in which the tab and the seal section are configured together as one piece. With a single-layer tab, the stronger joining of the seal can be effected in a comparatively material-saving manner in particular by the enlargement of the joining surface.

In alternative embodiments of the filter element, the first tab is embodied as multi-layered, in particular double layered. In this way, the tab comprises a particularly high bending stiffness. The two layers of the tab may be connected to each other by a bent section of the tab or a fold edge. In such an embodiment, the side strip is in particular designed in cross section with a T profile. This T profile maybe be a combination of two L profiles resting against each other. One leg of one L profile may rest against a leg of the other L profile. The legs of the L profiles which are not resting against each other can extend along the seal section, in particular in vertical axis direction, or form the seal section.

In a further development of the aforementioned embodiment, the two layers of the first tab may be glued to each other. In this way, a displacement of the layers of the tab relative to each other is prevented so that the stability of the tab is further increased.

In one embodiment of the filter element, the first tab is glued to the seal section of the first side strip. Gluing effects in a time-saving manner the attachment of the tab at the seal section.

In advantageous embodiments of the filter element, the first tab and the seal section of the first side strip are embodied together as one piece. In this way, the tab is particularly stably connected to the seal section.

Advantageously, the first side strip is comprised of a nonwoven material or cardboard. Such fiber materials are inexpensive in regard to manufacture. Furthermore, they can be easily recycled. In particular cardboard is characterized by a high bending stiffness and relatively minimal production costs.

In one example, the first tab comprises through openings through which the seal passes. The seal covers oppositely positioned side faces of the tab and passes through the through openings. In this way, the tab and the seal provide a form fit connection in the region of the through openings in order to hold the seal particularly stably at the tab.

In advantageous embodiments, the seal is comprised of a foamed material, in particular polyurethane foam. By using foam as a material, the seal can be applied in a simple manner directly onto the tab so as to match the shape of the tab. Polyurethane foam can be produced in various degrees of hardness and density and comprises advantageous properties for the use in air filters.

Some embodiments of the filter element comprise a second side strip with a second tab, wherein the second side strip seals the filter body at a second end face which extends transversely to the fold edges. The filter body is disposed between the first side strip and the second side strip. The second side strip effects a sealing action of the filter element in that it covers the second end face of the filter body. The second tab effects a stronger joining of the seal to the second side strip and thus to the filter element. The second side strip may be designed like the first side strip. The second tab may be designed in particular like the first tab.

In a further development of the aforementioned embodiments, between the first side strip and the second side strip, a third and a fourth tab may be arranged at the filter body, wherein the first tab, second tab, third tab, and fourth tab adjoin each other in pairs and surround the filter body. The third tab and fourth tab extend respectively from the first side strip to the second side strip. The third tab and the fourth tab are oriented away from the filter body, in particular outwardly. Due to the four tabs, the seal is more strongly joined and reinforced along its entire circumference.

In further embodiments, a reinforcement element may be arranged at least at the first tab, wherein the reinforcement element may be configured in particular as a circumferential plastic ring. Due to the reinforcement element, the bending stiffness of the tab is further increased. In some embodiments, the reinforcement element is resting on the tab. In particular, the reinforcement element is connected to the tab by material fusion and/or form fit, and may be inserted into the tab and/or glued in. The latter concerns embodiments in which the tab is designed of a double-layer configuration. The reinforcement element may be arranged at the first tab, second tab, third tab, and fourth tab of the filter element.

A further embodiment of the filter element is characterized by at least one head strip, in particular a plurality of head strips, at one end surface. The end surface or the head strip extends perpendicularly to the seal section and along a lateral edge of the seal section. The head strips and the side strips together may form a circumferential complete strip which completely seals the filter element laterally.

The air filter according to the invention comprises a filter element according to the invention as described above and a filter housing that comprises a filter pot and a filter cover, wherein the seal is held by being clamped between the filter pot and the filter cover. The filter housing in general has an inlet for contaminated air and an outlet for the air purified by the filter element. The seal seals the filter element in relation to the filter housing so that contaminated air cannot flow past the filter element through the filter housing. The seal separates a raw side and a clean side of the air filter from each other.

The filter device according to the invention comprises a filter element according to one of the aforementioned embodiments and a flow channel through which an air flow can flow, wherein the filter element extends perpendicularly to the direction of the air flow through the flow channel and may be held in the flow channel by engagement of a profile frame.

The filter element divides the flow channel into a raw air side and a clean air side. Contaminated air flows in an air flow from the raw air side to the clean air side through the filter element. The filter element may be fastened in the flow channel by engaging, in particular by friction fit and/or form fit, a profile frame. The filter element is held in the profile frame in particular by a clamping force on the seal of the filter element. The profile frame comprises a height of 16 mm to 21 mm and a depth of 20 mm to 25 mm. The profile frame is designed according to the standard DIN EN 15805. The flow channel can be furnished with a servicing access. In one embodiment, the filter device is used in systems for the air supply of buildings.

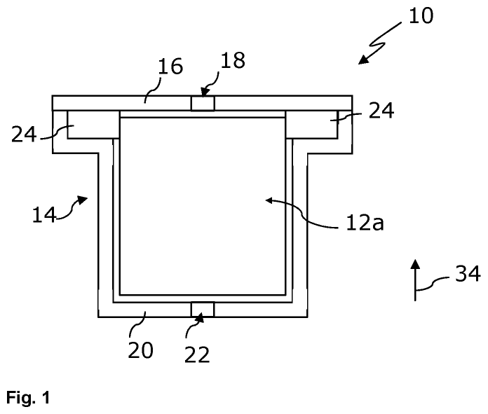

FIG. 1 shows schematically a cross section of an air filter 10 with a filter element 12a according to the invention. The filter element 12a is held in a filter housing 14. The filter housing 14 comprises a filter cover 16 with an inlet 18 for contaminated air and a filter pot 20 with an outlet 22 for air purified by the filter element 12a. The contaminated air flows from the inlet 18 through the filter element 12a where it is cleaned and flows subsequently through the outlet 22 out of the filter housing 14. A circumferential seal 24 of the filter element 12a is held by being clamped between the filter pot 20 and the filter cover 16. The seal 24 prevents that contaminated air flows past the filter element 12a in the filter housing 14. Furthermore, the seal 24 fixes the filter element 12a in the filter housing 14.

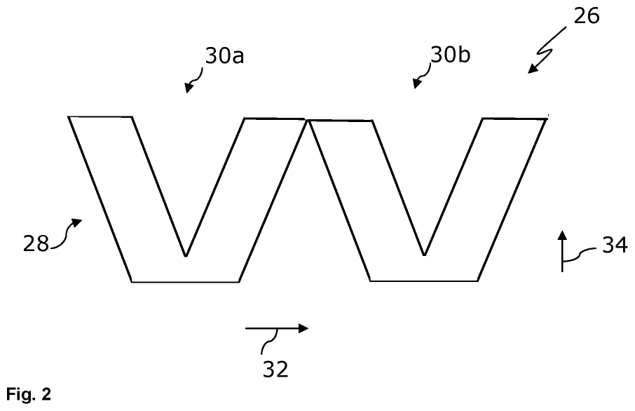

FIG. 2 shows a schematic longitudinal section through a filter body 26 of the filter element 12a (see FIG. 1). The filter body 26 has a profile 28 that is combined of individual bellows 30a, 30b which have the same shape and adjoin each other in a length direction 32 of the filter body 26. In particular, the profile 28 is combined of repeating individual bellows 30a, 30b adjoining each other. The individual bellows 30a, 30b are designed to be upwardly open in a vertical axis direction 34 which is perpendicular to the length direction 32. The length direction 32 extends perpendicularly to the drawing plane in FIG. 1.

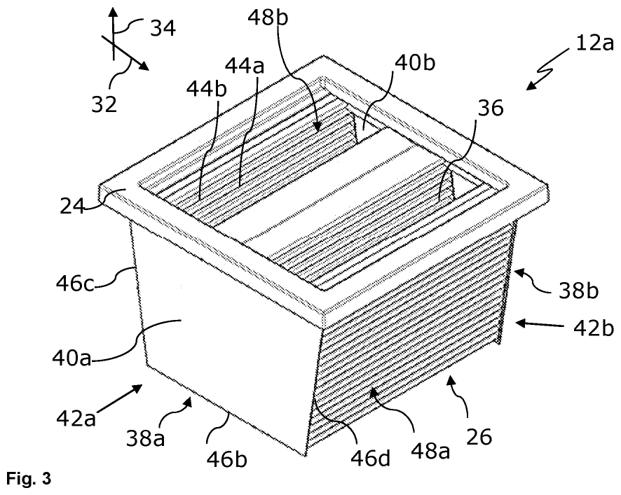

FIG. 3 shows an isometric view of a first embodiment of the filter element 12a. The filter body 26 of the filter element 12a comprises a folded filter medium 36 for cleaning the contaminated air. A first side strip 38a and a second side strip 38b of the filter element 12a are comprised of a fibrous material. The first side strip 38a comprises a first seal section 40a and the second side strips 38b a second seal section 40b for sealing the filter body 26; they are arranged, transverse to fold edges 44a, 44b of the filter medium 36, at first and second end faces 42a, 42b which are oppositely positioned relative to each other.

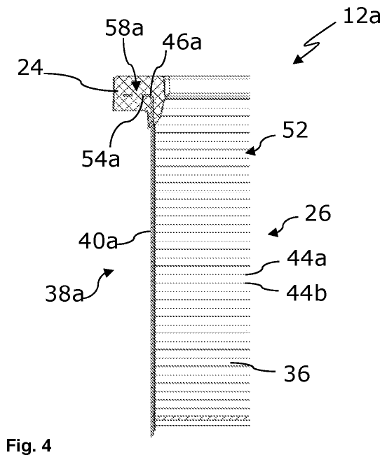

The filter body 26 extends in the vertical axis direction 34, which is positioned perpendicularly to the longitudinal direction 32 and perpendicularly to the orientation of the fold edges 44a, 44b, from a top edge 46a (see FIG. 4) of the respective seal section 40a, 40b to a bottom edge 46b of the respective seal section 40a, 40b. The top edge 46a and the bottom edge 46b of the respective seal section 40a, 40b extend in the length direction 32. The lateral edges 46c, 46d of the respective seal section 40a, 40b extend from the top edge 46a to the bottom edge 46b, here at a slant to the length direction 32 and to the vertical axis direction 34. The edges 46a-46d are illustrated in an exemplary fashion at the first seal section 40a. A first end surface 48a and a second end surface 48b of the filter body 26 extend perpendicularly to the seal sections 40a, 40b and along the lateral edges 46c, 46d of the seal sections 40a, 40b and form outer surfaces of the filter element 12a in the length direction 32.

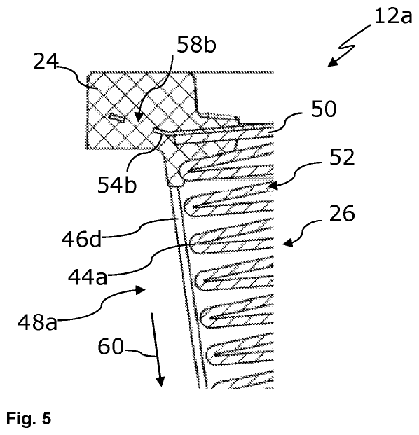

At the top edge 46a of the seal sections 40a, 40b and at end folds 50 (see FIG. 5) of the end surfaces 48a, 48b, the seal 24 surrounds continuously the filter body 26 in order to seal the filter element 12a in relation to the filter housing 14 (see FIG. 1).

In FIG. 4, a cross section through the first embodiment of the filter element 12a in the region of the first side strip 38a is illustrated. Inter alia, the seal section 40a of the first side strip 38a at which the folds 52 of the filter body 26 end is illustrated. The seal section 40a passes into a terminal tab 54a arranged at the top edge 46a of the seal section 40a and projecting away from the seal section 40a in the direction of the fold edges 44a, 44b of the folds 52. The first side strip 38a is embodied here as one piece; the same piece of fibrous material forms the seal section 40a and the first tab 54a.

The first tab 54a is oriented away from the filter body 26. The first tab 54a is immersed in the seal 24 so that the seal 24 engages around the first tab 54a.

In the illustrated first embodiment of the filter element 12a, the first tab 54a is of a single layer configuration and forms with the seal section 40a an L profile in cross section. The seal 24 passes through the through opening 58a of the first tab 54a in order to fasten the seal 24 more stably at the first tab 54a. The seal 24 extends from the first tab 54a to at least some of the folds 52 of the filter body 26 to which it is fixedly connected and in which it engages. In this way, the seal 24, in addition to sealing the filter element 12a in relation to the filter housing 14 (see FIG. 1), effects a better fastening of the filter body 26 to the first side strip 38a. The second side strip 38b comprises a second tab, not illustrated in detail, which corresponds to the first tab 54a.

FIG. 5 shows a longitudinal section through the first embodiment of the filter element 12a in the region of the first end surface 48a. The folds 52 of the filter body 26 are sequentially folded at the legs of the V profiles (see FIG. 2) in a folding direction 60 which is parallel to the lateral edge 46d of the first seal section 40a (see FIG. 3). At an end fold 50 of the filter body 26, a third tab 54b is fastened, in particular glued, wherein the third tab 54b is enclosed by the seal 24. The third tab 54b comprises also a through opening 58b through which the seal 24 passes in order to fasten the seal 24 better at the third tab 54b. In this context, the third tab 54b is positioned at a slant to the fold direction 60 of the folds 52 of the filter body 26. At the second end surface 48b, a fourth tab, not illustrated in detail, corresponding to the third tab 54b is arranged.

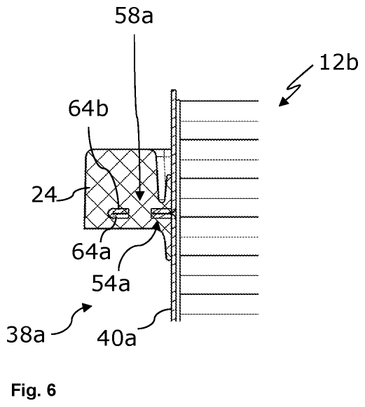

FIG. 6 shows a cross section through a second embodiment of the filter element 12b in the region of the first seal section 40a. In contrast to the first embodiment of the filter element 12a (see FIG. 4), the first tab 54a is here of a double-layer configuration, likewise the second tab, not illustrated, at the second seal section 40b. The first side strip 38a or the first tab 54a together with the first seal section 40a have a T profile in cross section. The first seal section 40a extends at both sides of the first tab 54a, wherein the first seal section 40a with a respective one of the layers 64a, 64b of the double-layer first tab 54a forms an L profile in cross section. The two layers 64a, 64b of the first tab 54a pass into each other via a curved section of the first tab 54a. The seal 24 encloses both layers 64a, 64b of the first tab 54a and passes through a through opening 58a which extends through both layers 64a, 64b.

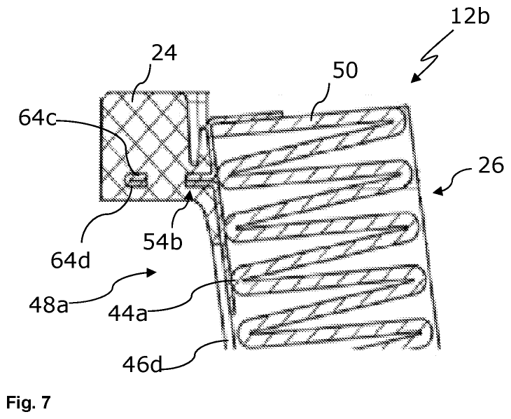

FIG. 7 shows a longitudinal section through the second embodiment of the filter element 12b in the region of the first end surface 48a. In contrast to the first embodiment of the filter element 12a, the third tab 54b is also of a double-layer configuration, likewise a fourth tab, not illustrated, at the second end surface 48b. The two layers 64c, 64d of the third tab 54b form in cross section a respective leg of an L profile. The layers 64c, 64d resting against each other and connected by a curved section of the tab 54b are oriented in such a way at an angle to the first end surface 48a, which extends parallel to the lateral edge 46d of the seal section 40a (see FIG. 3), that they are oriented parallel to the length extension 32 (see FIG. 3) of the filter body 26. The third tab 54b is fastened to the adjoining end folds 50 of the filter body 26, in particular glued, and can be supported at fold edges 44a of the first end surface 48a.

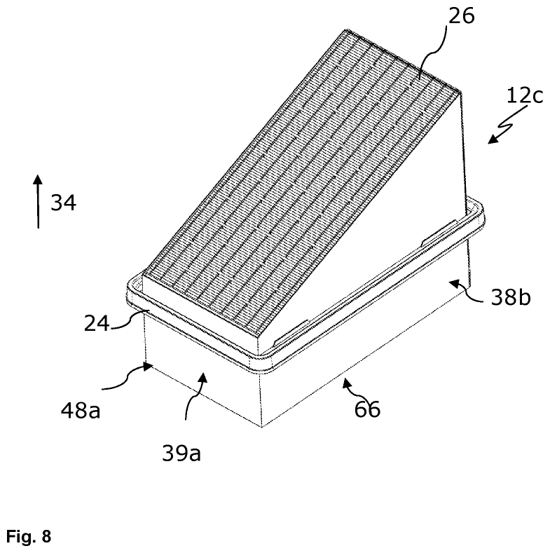

FIG. 8 shows a schematic perspective view of a third embodiment of the filter element 12c, which comprises, aside from the side strips 38a, 38b (see FIG. 3) of which in the Figure in an exemplary fashion the side strip 38b can be seen, head strips at the end surfaces 48a, 48b (see FIG. 3). An exemplary head strip 39a can be seen in FIG. 8. The head strips serve in particular for sealing the end surfaces 48a, 48b. The head strips and the side strips 38a, 38b together form a circumferential complete strip 66 which laterally seals the filter element 12c with the seal 24. The head strips and/or the side strips 38a, 38b comprise in particular cardboard as material. In vertical axis direction 34, the filter body 26 projects with a surface that is slanted in relation to the vertical axis direction 34 past the seal 24. The filter body 26 can have folds of different height so that a height of the filter element 12c increases, for example, from the end surface 48a toward the end surface 48b. In this context, the tabs for connecting the seal can advantageously be formed by folding the respective side strips 38a, 38b as well as head strips 39a, 39b and can thus be of a double-layer configuration. As an alternative, a two-part configuration of the side strips and/or head strips is possible, i.e., two seal sections are applied with overlap to the respective side face of the filter body to be covered and, at the seal section lying on top of the other one, the tab is formed by bending the free end section. In this way, the configuration of a single-layer tab would be possible even at a spacing from inflow side or outflow side. The seal may be foamed onto the tab.

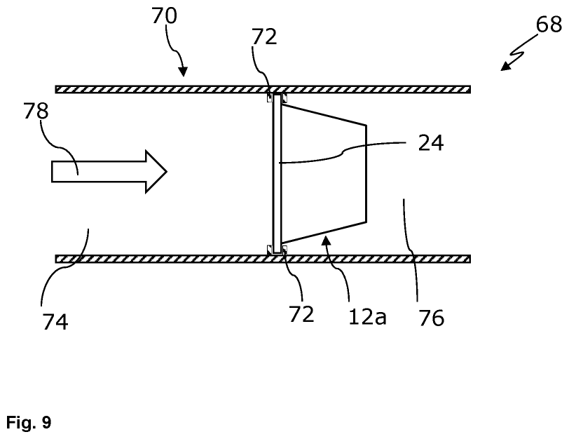

FIG. 9 shows schematically a filter device 68 with a flow channel 70 in which a filter element, here in an exemplary fashion in the first embodiment 12a, is held by a profile frame 72. The filter element 12a extends through the cross section of the flow channel 70. In this way, the filter element 12a divides the flow channel 70 into a raw air side 74 and a clean air side 76. Contaminated air flows in an air flow 78 from the raw air side 74 to the clean air side 76 through the filter element 12a. The filter element 12a is held in the profile frame 72 in particular with friction fit and/or form fit, for example, by a clamping force on the seal 24. The flow channel 70 can be furnished with a servicing access, not illustrated.

### LIST OF REFERENCE CHARACTERS

10 air filter
12a, 12b, 12c filter element
14 filter housing
16 filter cover
18 inlet
20 filter pot
22 outlet
24 seal
26 filter body
28 profile of the filter body
30a, b individual bellows
32 length direction
34 vertical axis direction
36 filter medium
38a, b side strip
39a head strip
40a, b seal sections
42a, b end faces
44a, b fold edges
46a, b top, bottom edge of seal section
46c, d lateral edges of the seal section
48a, b end surfaces
50 end fold
52 folds
54a first tab
54b third tab
58a, b through openings
60 fold direction
64a-d layers of tabs
66 complete strip
68 filter device
70 flow channel
72 profile frame
74 raw air side
76 clean air side
78 air flow

What is claimed is:

1. A filter element for filtering air, the filter element comprising:
a filter body comprising a folded filter medium with fold edges;
a first side strip comprised of a fibrous material, wherein the first side strip comprises a seal section, wherein the seal section seals the filter body at a first end face extending transversely to the fold edges of the filter medium, and wherein the first side strip further comprises a first tab projecting away from the seal section and extending in a direction of the fold edges;
a circumferential seal engaging around the first tab.

2. The filter element according to claim 1, wherein the first tab is arranged terminally at the seal section.

3. The filter element according to claim 1, wherein the seal section extends at both sides of the first tab.

4. The filter element according to claim 1, wherein the first tab is a single layer.

5. The filter element according to claim 1, wherein the first tab is multi-layered.

6. The filter element according to claim 5, wherein the first tab is comprised of two layers.

7. The filter element according to claim 6, wherein the two layers are glued to each other.

8. The filter element according to claim 1, wherein the first tab is glued to the seal section of the first side strip.

9. The filter element according to claim 1, wherein the first tab and the seal section of the first side strip are configured together as one piece.

10. The filter element according to claim 1, wherein the first side strip is comprised of a nonwoven material or of cardboard.

11. The filter element according to claim 1, wherein the first tab comprises through openings and the circumferential seal passes through the through openings.

12. The filter element according to claim 1, wherein the circumferential seal is comprised of a foamed material.

13. The filter element according to claim 12, wherein the foamed material is a polyurethane foam.

14. The filter element according to claim 1, further comprising a second side strip comprising a second tab, wherein the second side strip seals the filter body at a second end face extending transversely to the fold edges.

15. The filter element according to claim 14, further comprising a third tab and a fourth tab, wherein the third tab and the fourth tab are arranged at the filter body between the first side strip and the second side strip, wherein the first tab, the second tab, the third tab, and the fourth tab adjoin each other in pairs and surround the filter body.

16. The filter element according to claim 15, further comprising one or more reinforcement elements, wherein at least at the first tab one of the reinforcement elements is arranged.

17. The filter element according to claim 16, wherein the one or more reinforcement elements are circumferential plastic rings.

18. The filter element according to claim 1, further comprising a reinforcement element arranged at the first tab.

19. The filter element according to claim 18, wherein the reinforcement element is a circumferential plastic ring.

20. The filter element according to claim 1, further comprising at least one head strip at an end surface of the filter body, wherein the end surface of the filter body extends perpendicularly to the seal section and along a lateral edge of the seal section.
